(19) United States
(12) Patent Application Publication
(10) Pub. No.: US 2025/0054132 A1
(43) Pub. Date: Feb. 13, 2025

(54) METHOD OF TRAINING A NEURAL NETWORK FOR DETECTING ANOMALIES IN A MANUFACTURING PRODUCT, METHOD OF DETECTING ANOMALIES IN A MANUFACTURING PRODUCT, INSPECTION SYSTEM AND NON-TRANSITORY COMPUTER READABLE MEDIUM

(71) Applicants: SAMSUNG ELETRÔNICA DA AMAZÔNIA LTDA., Campinas (BR); UNIVERSIDADE ESTADUAL DE CAMPINAS, Campinas (BR)

(72) Inventors: YUZO IANO, Campinas (BR); RANGEL ARTHUR, Limeira (BR); GIULLIANO PAES CARNIELLI, Campinas (BR); JÚLIO CÉSAR PEREIRA, Campinas (BR); LUÍS AUGUSTO LIBÓRIO OLIVEIRA FONSECA, Campinas (BR); JUAN CARLOS MINANGO NEGRETE, Campinas (BR); ALEX MIDWAR RODRIGUEZ RUELAS, Campinas (BR); ANGÉLICA MOISES ARTHUR, Campinas (BR); GABRIEL GOMES DE OLIVEIRA, Campinas (BR); GABRIEL CAUMO VAZ, Campinas (BR); MARCOS ANTONIO ANDRADE, Campinas (BR)

(73) Assignees: SAMSUNG ELETRÔNICA DA AMAZÔNIA LTDA., CAMPINAS (BR); UNIVERSIDADE ESTADUAL DE CAMPINAS, CAMPINAS (BR)

(21) Appl. No.: 18/241,368

(22) Filed: Sep. 1, 2023

(30) Foreign Application Priority Data
Aug. 8, 2023 (BR) 10 2023 015958-3

(51) Int. Cl. G06T 7/00; G06V 10/20; G06V 10/774

(52) U.S. Cl. CPC G06T 7/001; G06V 10/20; G06V 10/774; G06T 2207/20081; G06T 2207/20084; G06T 2207/30141

(57) ABSTRACT

The present invention refers to a method of training a neural network to detect anomalies in a manufacturing product comprising: obtaining a dataset including multiple manufacturing product images and annotation files with coordinates of predetermined anomalous regions corresponding to the manufacturing product images, respectively; selecting a test query set of images and a support set of images from the dataset multiple to train a deep learning model, the support set of images comprises pairs of reference images and each pair comprises at least one anomalous manufacturing product image and at least one non-anomalous manufacturing product image; inputting the test query set into a deep learning model to rate a similarity score based on a similarity distance between the pairs of reference images of the support set based on the annotation files; and adjusting parameters characterizing the deep learning model through a model based on the similarity score.

### CROSS-REFERENCE TO RELATED APPLICATION(S)

This application is based on and claims priority under 35 U.S.C. § 119 to Brazilian Patent Application No. BR 10 2023 015958-3, filed on Aug. 8, 2023, in the Brazilian Intellectual Property Office, the disclosure of which is incorporated by reference herein in its entirety.

### FIELD OF THE DISCLOSURE

The present invention is related to real-time anomaly detection problems in industrial manufacturing lines. More specifically, the present invention refers to a new robust Deep Anomaly Detector, DAD, targeted by manufacturing industries which constantly renews their products and do not have representative data samples at the start of their production.

### DESCRIPTION OF RELATED ART

Industrial product manufacturing is commonly vulnerable to failures in almost any production operation. When defective products pass undetected during the manufacturing process, they may be shipped to the market, possibly harming the company's business in several ways, from issues with warranty administration to loss of market share based on its image quality control. To contour this situation, a previous quality control protocol is desired.

Defective samples are usually non-representative among the entire set of parts in the manufacturing line. Still, they are a vital subject to be tracked and post-processed. Installing accurate anomaly detection systems in production lines is a common goal for many manufacturing companies. However, such work still depends on a specialized human professional to inspect their products for defects, which is an expensive and limited way of inspection for a whole production line, usually made in packs, not product by product, due to inspection speed limits (e.g., a smartphone line operates in the order of 10³ samples per day). This is barely an impossible task for a single human to inspect.

With the advent of machine learning, more focused on deep learning, inspection systems based on computer vision are now a high-standard available technology. But they tend to be expensive in terms of data acquisition. Deep learning vision systems usually depend on datasets composed of thousands of images to prepare the model for a robust and practical application. Still, they are usually not proof of concept drift, which makes human specialists still necessary, even if he has a limited inspection speed.

In the manufacturing industry, a product renewing cycle is ubiquitous, for example, smartphones, televisions, cameras, home appliances, etc. This relatively high frequency of the product renewing cycle is a barrier to generating substantial and robust datasets to serve deep learning models further.

In view of the issues above, the state of the art comprises solutions based on machine learning models to inspect anomalies or defects based on computer visual inspection.

The patent document U.S. Ser. No. 11/222,234B2, entitled: “Method and apparatus for training a convolutional neural network to detect defects”, published on Jan. 1, 2022, describes a method based on convolutional neural networks (CNNs) to learn how to detect electronic solder joint defects on shell surfaces. The system is based on pre-defined training samples with examples of solder defects, with a fixed softmax output, i.e., a class-specific system. However, U.S. Ser. No. 11/222,234B2 does not show how to turn a similar approach into a class-agnostic classifier capable of being implemented on different product versions from the ones it was trained at.

The patent document U.S. Ser. No. 10/860,879B2, entitled: “Deep convolutional neural networks for crack detection from image data”, published on Dec. 8, 2020, presents a surface crack detection system that, similarly to the present invention, is capable of dividing the query image into patches and classify them individually, but the patches are insensitive to the context, made of systematic crops of the image, taking a substantial risk of dividing a critical part of the product into two or more parts, losing its context and further increasing the risk of miss classification. Notwithstanding, the region of interest detection operation in the cited document is based on manual digital image morphology transformation and filtering. Yet, U.S. Ser. No. 10/860,879B2 does not present a solution that solves the same stage with an automatic machine learning detector that can easily adapt to new products based on meta-learning techniques. Finally, as document U.S. Ser. No. 11/222,234B2, document U.S. Ser. No. 10/860,879B2 is also a class-specific solution, which requires significantly representative and balanced datasets.

The patent document U.S. Ser. No. 11/334,407B2, entitled: “Abnormality detection system, abnormality detection method, abnormality detection program, and method for generating learned model”, published on Jan. 14, 2021, describes an invention to detect defects in complex systems based on the data collection of a high-density sensor network inserted into an autoencoder-based deep learning model, which should be able to reconstruct the input data, and return an emphasized signal if some unknown outlier data was passed through the sensor network. Besides the class-agnostic capacity of this method, it still requires a representative dataset size, as the autoencoder approach learns the data probability distribution based on a single test sample per inference. Thus, U.S. Ser. No. 11/334,407B2 does not contours the high data-demanding scenario with the meta-metric-learning approach and do not have the product-agnostic attribute. The described autoencoder cannot generalize its inferences toward products with different versions from those present in the training dataset. In other words, if the autoencoder trains to recompose devices A, B, and C, it cannot be applied to devices D or E.

The paper document 10.1109/CVPR.2015.7298682, entitled: “FaceNet: A unified embedding for face recognition and clustering,” published on Jun. 12, 2015, describes a similar approach to the present invention but focused on face recognition task instead of anomaly detection. Supposing a company wants a system to recognize all its employees' faces for security purposes. Such a system may need thousands of face samples for training, but still, it would not recognize faces from new people who have never been seen during training. If the company is forced to retrain its model whenever a new employee is hired, such a solution would quickly become inviable. The FaceNet paper shows how a meta-learning approach can address this issue. However, this approach does not seem to be popular for anomaly detection tasks, probably, due to the poor supply of anomalous samples to serve as primary training data, which is an issue that does not hinder the FaceNet task. The present invention takes advantage of a restricted context of the industrial manufacturing scenario (e.g., a repetitive task such as smartphone inspection) to develop synthetic anomalous features over non-defective data samples and make it possible to use meta-learning in a DAD system. Combining these two techniques has brought about an efficient and innovative method for anomaly detection frameworks.

The patent document KR20230030259, entitled: “Deep learning-based data augmentation method for product defect detection learning”, published on Mar. 6, 2023, describes a method of data augmentation, based on a deep learning technique using GAN (Generative Adversarial Network), for producing new images already associated with each existing deformity domain, automatically preserving the labels used to classify the original images. Therefore, KR20230030259 describes a method for creating datasets meant to training defect detection methods. The present invention, on the other hand, describes a method for detecting anomalies or defects in PCBs, which is robust to the concept drift issue and adheres to the Few-Shot Learning method. Thus, the purpose of the work KR20230030259 is utterly different from the present invention, having no concept overlapping between both works.

The patent document KR2477088, entitled: “A Method for Adjusting an Inspection Area and a device for Adjusting an Inspection Area”, published on Dec. 8, 2022, utilizes a similarity learning approach to detect anomalies, however, its core application is related to video abnormal-patterns detection. The similarity model is applied to a sequential frame data, where the present frame is compared with the past frames, looking for significant changes in the timeline record. While this application seems to return a significant motion pattern detection, including video-adaptive thresholds, the proposed invention cares to detect relatively tiny PCB defects, that which are correlated to manufacture defects, even in coming products, and, possibly, were never present in the training dataset. Furthermore, the present invention deals with object detection in situations comprising extremely small defects, in relation to the whole image, by applying a deep learning model for automatic patch extraction, which can extract pre-specified regions of interest in the PCB, handing them to the similarity module, which is not related with motion detection, in any level.

The patent document US20220392051, entitled: “Method and Apparatus with image analysis”, published on Dec. 8, 2022, describes a method for image analysis that includes: receiving a test image; generating a plurality of augmented images by geometric transformations; classification using entropy values; determining a detection score based on the prediction values classification; and determining whether the test image corresponds to anomaly data, based on the detection score and a threshold. The anomaly data must be data outside a range of training data used during a training process of the classifier, and the normal data may be data within the range of training data used during the training process of the classifier. It exemplifies how the cited method is not concept-drift-proof, since the test data will always be outside the range of the training data. The present invention is different because includes techniques that utilize classification of different regions of the image as normal and abnormal and metric learning in concept-drift.

The patent document U.S. Ser. No. 11/199,506, entitled: “Generating a training set usable for examination of a semiconductor specimen”, published on Dec. 14, 2022, describes a method of generating a training set usable for examination of a semiconductor specimen. The method comprises: obtaining a simulation model capable of simulating effect of a physical process on fabrication process (FP) images, wherein simulation is dependable on values of parameters of the physical process; applying the simulation model to an augmented image training set and thereby generating one or more augmented images corresponding to one or more different values of the parameters of the physical process; and including the generated one or more augmented images into the training set. It relates to augmenting and synthesizing data collected from a manufacturing process, and adding the data into training data. The present invention is different because includes techniques that utilize classification of different regions of the image as normal and abnormal in concept-drift.

As a State-of-the-art example of anomaly detection systems based on visual inspection, a published paper named “Defect Detection in Printed Circuit Boards Using You-Only-Look-Once Convolutional Neural Networks”, published in https://www.mdpi.com/journal/electronics, on December September 2020, describes a deep learning model based on object detection task. The presented system was trained over 11000 images of printed circuit boards. As reported in the paper, it can detect and classify 11 defect classes with a mean accuracy of 98.79% on the presented dataset samples. Besides the considerably high accuracy, the authors did not report the precision and recall scores, both important when dealing with imbalanced anomaly detection systems. Another critical issue in the cited work is that the dataset samples were manually cropped into small ROIs. The introduced ODM was directly trained to get the anomalies. This approach restricts the application to the specific device domain at which the model has been introduced. The core effect of this kind of system is that after training, its inference operation depends on samples closely related to those used during the model's training operation. The model cannot identify some anomalies different from the 11 classes it was trained at. Furthermore, this application must operate with datasets with thousands of images to achieve a substantial efficacy score. The present invention's most innovative effect is to interrupt visual inspection systems' inter-data similarity dependency cycle without the onus of acquiring datasets with thousands of samples every time a new device enters the production line.

The prior art comprises systems that detects anomaly classes previously determined by the designer (e.g., scratched, burnt, dented, missing pieces, short circuits, open circuits, mouse bits, spur, etc.). Such types of systems are designed to find specific problems in specific products. A traditional deep learning-based feature extractor combines a classifier and detector artificial network. They are usually presented as object detection models trained in thousands of supervised images to find specific objects in some pre-defined context. Accurate and fast DAD systems but substantially vulnerable to concept drift and consequently not data efficient.

A product manufacturing cycle usually lacks a representative dataset supply at the start of its production, yielding a very restricted number of flawed samples. These circumstances turn a specialized human inspector into an essential demand. However, since human inspection speed is limited, the inspector(s) must asynchronously analyze the assembly line, getting at most a dozen samples per production lot, inevitably introducing inspection failure risks.

An automatic anomaly inspection system, which fits the described circumstances, must be modeled based on past produced device samples, with restricted anomaly representativeness, but still be able to adapt to new device versions efficiently.

Therefore, the prior art lacks a solution for real time detecting printed circuit board, PCB, anomalies in industrial manufacturing scenarios without using a robust base of anomaly images under concept drift, where the product's architecture and main features change periodically.

### SUMMARY OF THE INVENTION

The proposed invention aims to provide a method for real time detecting anomalies in industrial manufacturing scenarios, such as in the manufacturing of printed circuit board (PCB), without using a robust base of anomaly images under concept drift, where the product's architecture and main features change periodically.

Another objective of the present invention is to provide an accurate, fast and also substantially more generalizable and a data-efficient DAD system. Thus, the present invention also aims at providing a solution that can adapt to changing inspection scenarios, even without a large training dataset.

Aiming at achieving the objectives above, the present invention refers to a method of training a neural network for detecting anomalies in a manufacturing product, comprising: obtaining a dataset including multiple manufacturing product images and annotation files with coordinates of predetermined anomalous regions on each manufacturing product image; selecting a test query set and a support set of images from the dataset multiple times to train a deep learning model, wherein the support set of images comprises pairs of reference images and each pair comprises at least one anomalous and one non-anomalous manufacturing product images; inputting the test query set into a deep learning model to rate a similarity score based on the similarity distance between pairs of reference images of the support set based on the annotation files; and adjusting the parameters characterizing the deep learning model through a model based on the similarity score.

Moreover, the present invention refers to a method of detecting anomalies in a manufacturing product, comprising: obtaining at least one image of a manufacturing product to be inspected; inputting the obtained image in a neural network trained to compare a manufacturing product image with pairs of reference images comprising one anomalous and one non-anomalous manufacturing product images, wherein the reference images are stored as a support set; rating the similarity distance score between the obtained image and the pairs of reference images; and determining whether the manufacturing product is anomalous with basis on the similarity distance score.

Furthermore, the present invention refers to an inspection system for detecting anomalies in a manufacturing product comprising: an imaging system configured to obtain an image of a manufacturing product; and a computer system comprising a memory device and a processor, wherein the computer system is connected to the imaging system;

the processor is configured to: obtaining at least one image of a manufacturing product to be inspected; inputting the obtained image in a neural network trained to compare a manufacturing product image with pairs of reference images comprising one anomalous and one non-anomalous manufacturing product images, wherein the reference images are stored as a support set.

The present invention is also related to a non-transitory computer-readable storage medium adapted for performing the method according to the embodiments described herein.

### BRIEF DESCRIPTION OF THE DRAWINGS

The invention is explained in greater detail below and references the drawings and figures attached herewith, when necessary. Attached herewith are the following:

FIG. 1 shows an illustrative example of the proposed solution's application according to an embodiment of the present invention.

FIG. 2 presents the symbolic structure of the macro components according to an embodiment of the present invention.

FIG. 3 depicts the general flow of information and operations according to an embodiment of the present invention.

FIG. 4 illustrates the logical flow of the program ROIAL according to an embodiment of the present invention.

FIG. 5 illustrates the proposed solution's application changes according to an embodiment of the present invention.

FIG. 6 depicts the general flow of information and operations according to an embodiment of the present invention.

FIG. 7 shows the averaged curve performance results for multiple model experiments according to an embodiment of the present invention.

### DETAILED DESCRIPTION OF THE INVENTION

The present invention refers to a method of training a neural network for detecting anomalies in a manufacturing product comprising: obtaining a dataset including multiple manufacturing product images and annotation files with coordinates of predetermined anomalous regions on each manufacturing product image; selecting a test query set and a support set of images from the dataset multiple times to train a deep learning model, wherein the support set of images comprises pairs of reference images and each pair comprises one anomalous and one non-anomalous manufacturing product images; inputting the test query set into a deep learning model to rate a similarity score based on the similarity distance between pairs of reference images of the support set based on the annotation files; and adjusting the parameters characterizing the deep learning model through a model based on the similarity score.

Furthermore, the present invention also refers to a method of detecting anomalies in a manufacturing product comprising: obtaining at least one image of a manufacturing product to be inspected; inputting the obtained image in a neural network trained to compare a manufacturing product image with pairs of reference images comprising one anomalous and one non-anomalous manufacturing product images, wherein the reference images are stored as a support set; rating the similarity distance score between the obtained image and the pairs of reference images; and determining whether the manufacturing product is anomalous with basis on the similarity distance score.

Moreover, the present invention refers to an inspection system for detecting anomalies in a manufacturing product comprising: an imaging system configured to obtain an image of a manufacturing product; and a computer system comprising a memory device and a processor, wherein the computer system is connected to the imaging system; the processor is configured to: obtaining at least one image of a manufacturing product to be inspected; inputting the obtained image in a neural network trained to compare a manufacturing product image with pairs of reference images comprising at least one anomalous and one non-anomalous manufacturing product images, wherein the reference images are stored as a support set; rating the similarity distance score between the obtained image and the pairs of reference images; and determining whether the manufacturing product is anomalous with basis on the similarity distance score.

The present invention refers to an anomaly detection system based on image processing through deep learning techniques. Its core innovation features combine three main paradigms and two improvement assets: the paradigms are metric learning, meta-learning, and few-shot learning, and the assets are automatic patch extraction and synthetic anomalous data. These concepts were put together to compose a model that can extract a similarity score between input samples, classifying multiple regions of the product as normal or anomalous.

The standard implementation protocol starts with the problem definition process. The target product for inspection must be specified as first-domain information filtering; for example, restrict the Deep Anomaly Detector, DAD, system to detect anomalies in smartphone circuit brackets at some critical production line point (e.g., some specific point in the conveyor belt where the image-acquisition system is installed and may take pictures of each bracket that passes through).

Then, the next operation is the data engineering process, in which the designer must collect past data from the production line to compose the training dataset. Following the example of smartphone production, each phone model must be separated into folders called “superclasses.” Considering that the designer collected data from smartphone models A, B, and C. There must be three superclass folders, one for each smartphone model. Then, for each superclass folder, two inner folders must hold the “subclass” of that specific smartphone model. The subclass relates to the classification of the smartphone bracket as a binary state, “anomalous” or “normal”. Finally, the designer ends up with a structured dataset composed of images from multiple smartphones, separated first by model and then further segregated as defective or non-defective samples.

The industrial context may not afford to yield a representative number of anomalous samples. To cope with that scenario, the data augmentation implementation also involves synthesizing artificial anomalies over non-defective pieces, producing representative samples for defective items that are then used to train the DAD system.

The model may be trained with the structured dataset, and this approach has a critical training rule. Since this is a meta-learning model, the support and query sets must be composed of multiple pairs of smartphone bracket images. Thus, each pair must be formed of the same superclass samples, i.e., a support set with smartphone A must be paired with a query set of smartphone A. For each pair, a new smartphone type must be randomized so the model learns how not to pay attention to some specific smartphone and how to properly compare the input pair, regardless of the smartphone version.

At the end of the training operation, the model should have learned how to compare reference images (normal and flawed) against a test image, outputting the most similar reference it belongs to. This strategy of training allows the model to be exposed to new kinds of anomalies inside new versions of the manufactured device (smartphones D, E), never present in the training dataset, and still be able to recognize latent similarities that are closer to the defective reference samples than to the non-defective ones.

For further model effectiveness improvement, the present invention provides a DL pre-processing operation using an automatic patch extractor that may crop the original image into smaller high-resolution patches as regions of interest (ROI), containing less context information of the whole product, which leads to the model to avoid learning specific smartphone versions, since each patch pair shows more variation between each other than in comparison to complete image pairs. It is worth mentioning that this operation adds another data structure branch to the dataset. Each smartphone superclass will now have multiple superclasses for each ROI. Another data engineering tool, called ROIAL, is provided to make this structuring possible.

The present invention focuses on bringing a technology that turns the high data-demanding from deep learning systems into a vision system that is both generalizable for coming products and substantially data efficient. The most recent deep learning art supports the main inspiration of the present method, approaching the called metric, meta, and few-shot learning paradigms.

Traditional DL models are based on two modules, a feature extractor (FEM) and a classifier (CM). The former does the image embedding extraction (feature), a compact data structure called latent space, comprising a smaller dimensionality than the image itself. The feature carries the most relevant class characteristics that the image represents. Then, it is passed to the latter, the CM, which learns how to distribute the feature information between the system's classes. This classification strategy can be mathematically described by Eq. (1) and Eq. (2).

$$P ( {X}_{i} \vert {θ}_{h} ) = h ( {X}_{i} ) \qquad ( 1 )$$

$$h ( {X}_{i} ) = f ( g ( {X}_{i} ) ) \qquad ( 2 )$$

wherein the first term, P, is the class probability of Xi sample given the θ weights of the network h. The h function represents the whole network function, which can be separated into two functions, f, and g. g is the FEM, while f is the CM.

The problem starts when an anomaly is treated as a class to be detected and classified. Anomalies can happen in almost infinite ways, depending on the data structure. If the object characteristics are radically changed (different smartphone models), the traditional DAD system can quickly underfit.

To address this issue, anomaly detection systems are usually built around unsupervised clustering approaches. A DL model should learn to aggregate data points by their feature similarity, i.e., without a labeled sample supervising. This approach brings a robust generalization under imbalanced datasets, i.e., a high negative/positive sample ratio (e.g., credit card fraud datasets). However, the direct unsupervised learning approach leads to high data domain correlation. Considering that a model is trained with thousands of negative smartphone A samples (non-defective) and a few rare positives. That model will likely become highly specialized to detect anomalies exclusively on smartphone A. Once a new smartphone B is launched, the model drastically misfits its predictions due to concept drift. Thus, to fix that problem, a few more thousand samples from smartphone B must be collected, and the model must be retrained repeatedly.

The meta-learning paradigm radically changes the way of operation of deep learning models. Instead of giving a single test image to the model, as in traditional DAD systems, multiple image pairs are provided. Its core objective is to learn how to compare these pairs instead of directly classifying them. The pairs are given in a “query-support” style. The support set comprises reference samples, while the query sample is the image to be classified. The classification happens within a different module, the Similarity Module (SM), which compares the query samples against the support samples. Instead of learning features directly related to the object class, the model must learn the feature distance between the sample pairs, that is, the similarity distance between support and query.

When the similarity measure is based on the pairwise comparison, it can be called a Meta-metric learning system. This approach has been proven to be more data-efficient and robust to concept drift scenarios, i.e., the model does not need to learn specific class features to make accurate inferences. Essentially, it just learns to compare two or more images and returns the one that is more similar to the query, not inferring to which class it belongs; thus, the meta-learning learns to classify while learning to compare. Eq. (3) describes the mathematical representation of the meta-metric learning model:

$$P ( {X}_{i} \vert {θ}_{h} , {X}_{j} , {X}_{m} ) = f ( C ( g ( {X}_{i} ) , g ( {X}_{j} ) ) , C ( g ( {X}_{i} ) , g ( {X}_{m} ) ) ) \qquad ( 3 )$$

wherein P denotes the class probability of Xᵢ sample given the network weights θₕ and support samples Xᵢ and Xₘ, with j and m belonging to a different class (anomalous and non-anomalous, respectively), and C denotes the feature maps concatenation. The f function now represents the SM (Similarity Module) instead of the CM (Classification Module), which is responsible for extracting the similarity of each pair and determining the final class based on their values comparison. The most similar pair attributes represent the respective class.

In the context of anomaly detection framework, the present invention provides a meta-metric-learning system where the reference samples (support set) are composed of defective and non-defective samples (e.g., images of smartphone circuitry brackets with and without defects). The query is a randomly picked image (defective or non-defective) to be classified by the model. During the training operation, the model compares the query against the flawed and non-defective samples. As with any supervised learning approach, the model loss is reached based on the query similarity score against the actual query class. For example, considering that the query is a defective sample, the symbolic “distance” to the non-defective support image must be 1, and the distance to the defective support sample must be 0 (1 for very distant, 0 for closely related). This forces the model to learn how to compare the image pair similarities instead of trying to classify them directly.

The most feared problem in DL applied to small datasets is overfitting. Since DL models essentially learn how to interpolate the latent data space between samples, if the dataset is sufficiently small, the DL model may be capable of reaching the perfect interpolation representing this dataset, making perfect inferences inside it but poorly generalization in new data; the model memorizes the training data.

To mitigate the overfitting issue, another core technique used in this invention is few-shot learning. It comprises of a latent space grouping that provides for a more robust data probability distribution, working as a model regularizer (a mechanism to prevent overfitting). A quantifiable numeric space forms the feature embedding extracted by the FEM, i.e., the latent space, also called feature maps, when dealing with 2D data. Thus, it is compatible with arithmetic operations. For example, two image matrices from the same class (e.g., non-defective smartphone brackets), when element-wise averaged, can generate a new, roughly noised image without meaning. On the other hand, when feature maps are extracted from both images and averaged, a unique feature embedding will be produced that carries information from both images, but not all, just their average information. In other words, if both images belong to the same class, then both features carry some core information about this class and diminish possible noises from each image. The feature's average automatically makes the information interpolation. The averaged feature is between those two images not available in the dataset. Finally, the CM now learns to classify from the new feature, not an image-specific feature. This attribute brings a significant model generalization improvement when dealing with small datasets.

The number of averaged image embeddings is called K (K-shots). Theoretically, the few-shot technique has no limit for the value of K. The more average features, the more centralized the latent space gets, making it a more representative feature than a single image. In practice, experiments show an exponential decay in the representativeness addition of the feature in the function of the K value. Another limiting factor for the K value is the computational resources to train the model, as image-processing DL models usually consume a significant amount of memory. For practical purposes, the ideal K value usually ranges between 5-20, although the data domain and dataset representativeness will always be essential factors in defining the best K value. Eq. (4) describes the mathematical changes in the model function.

$$P ( {x}_{i} \vert {θ}_{h} , {X}_{{n}_{j}} , {X}_{{n}_{m}} ) = f ( C ( g ( {X}_{i} ) , \frac{1}{K} {\sum }_{n = 1}^{K} g ( {X}_{{n}_{j}} ) ) , C ( g ( {x}_{i} ) , \frac{1}{K} {\sum }_{n = 1}^{K} g ( {X}_{{n}_{m}} ) ) ) \qquad ( 4 )$$

The same notation of Eq. (3) goes for Eq. (4), except for adding the average terms for each support sample class, with K samples for each supported class.

The few-shot technique and meta-metric learning were both core techniques used in the present invention. Instead of the SM comparing the query feature against one non-anomalous and one anomalous feature, we pass multiple (K-shots) reference samples of both classes, averaging each group (K non-anomalous features and K abnormal features) before.

Another essential feature of the present invention is an automatic patch detection layer, also a deep learning-based approach where, instead of putting the model to be required to classify the whole image—defective or non-defective —, it automatically extracts coordinated patches of the image, then infers the anomaly classification for each region of interest (ROI) in the product, which was defined by the DAD designer criteria. This feature provides at least two advantages to the system. First, the model can point to a more specific region in the product instead of accusing the whole object as defective. This region can be previously defined as desired so that the designer can focus on critical areas of the product. Second, the image patching process provides another layer of training regularization (more robustness to overfitting and concept drift), an essential feature for deep learning systems applied under small datasets.

The patching operation applies a DL model, configured as an Object Detector Module (ODM), to identify the ROIs relevant to the analysis, selected at the DAD designer's discretion. Following the smartphone examples, a DAD designer can focus on regions of the bracket that contains critical components (e.g., vibration motors, cameras, capacitors, resistors, general integrated circuits, etc.). However, this kind of ODM is commonly presented, in the prior art, as the main DAD system, trained not to detect the critical ROIs but to search for anomalies directly, becoming a “closed-dataset” system, highly specialized to detect the types of defects it was trained at, but bad when a new smartphone appears, which is precisely the core problem cited in the present invention.

To address this issue, the present invention does not use the ODM to detect anomalies. Instead, it uses the ODM to find small, essential regions of the bracket, which changes remarkably the consequences. Since an industrial-manufactured object structure tends to be regular (i.e., each smartphone sample in the manufacturing line tends to be almost the same), it becomes a relatively easy task for the state-of-the-art (SOTA) ODMs to extract specific patches from it. If some flawed sample is presented to the ODM, it should not provide enough impact on the image core features to provoke some disturbance in the ODM's patch extraction.

Considering the designer decides to divide a bracket into four ROIs, the ODM must be trained to extract these ROIs from all images of that bracket in the dataset. Considering SOTA ODMs, there are versions capable of detecting 1000 different kinds of objects in the most varied contexts. Thus, it becomes a simple task for that ODM to tell apart only four classes (types of ROIs) in a strongly regular context (i.e., a smartphone production line returns almost equal samples each iteration). After using the ODM to extract the ROIs, the SM must receive them to calculate the similarity score. Instead of passing the whole image to the SM, the ROI pairs must be combined under the bracket area they were extracted. Now the SM needs to classify a smaller piece of the bracket, being exposed to less mutual information than the whole image; in other words, it's easier to compare small pairs of ROIs than a pair composed of the entire content simultaneously. Nonetheless, when a dataset comprises ROIs, not complete brackets, and the SM is trained over them, the information domain context disentangles into a more diverse latent space, which implies another level of concept drift regularization.

The last critical innovation used in the present invention is related to direct data manipulation. Before getting deeper into this subject, it is crucial to clarify the meaning of data augmentation (DA) for deep learning-based approaches. Consider that a classifier model must be trained to perform a simple task, such as discriminating dogs from cats, based on photographs of these animals. This model must learn fundamental representations of each class (cats and dogs) and filter class-restricted ones to discriminate them. However, depending on the dataset, it is necessary specific animal positions, fur sizes, fur color, eye color, tail sizes, etc. If the dataset is not sufficiently varied, the model may memorize these patterns and misfit new data, even if the same dog in the training dataset is tested by the model but photographed from another angle, another background, or another distance, any situation that modifies the context, but not the label reference (the same dog).

DA is a regularization technique to bring the model more data representativeness without acquiring more data. The designer can apply transformations to the original images in a way that changes their contents without changing their label. For example, the image can be rotated in some random range, flip it, change the brightness, the contrast, input some noise, shear, or zoom in and out; there is an extensive set of possible transformations. After applying multiple and randomly selected transformations for each image in the dataset, a more representative dataset is obtained without the effort to collect more data, sometimes a very expensive or even impossible task.

There is a relatively low frequency of anomaly occurrence in the manufacturing line. This means that a DL model that is trying to learn fundamental anomaly representations may quickly memorize them and not be able to generalize when there is a new kind of anomaly. Besides, if the focused dataset has significantly poor anomaly representativeness, classical DA techniques may not be enough. The present invention also explored a new type of DA, focused on anomaly detection frameworks to address this issue. It uses modern image edition software to manually input specific artifacts in non-defective sample images related to a real anomaly. To turn it into a more robust approach, a specialist in the data domain must be the one making the software anomaly synthesis, or at least a team composed of that specialist plus a digital designer professional to work together; this way, a better reliability to the synthetic anomalies is guaranteed, increasing their representativeness. Moreover, the anomaly synthesis must follow a systematic methodology in which new defective samples must have a single flaw. In fact, multiple flaws per sample are a rare phenomenon and, thus, could make the DAD detect an anomaly with less effort than for natural occurrences, leading to weaker confidence in realistic scenarios. Furthermore, each synthetic anomaly must be unique to express the rarity of natural flaws, otherwise, repetitive anomalies may represent vicious artifacts during the learning operation, in other words, very similar anomalies may lead the model to pay more attention to those features, which is not likely. Finally, once multiple non-defective samples are commonly supplied, the designer may preferably insert synthetic anomalies in every different non-defective sample as possible, that is, rather not use copies of the same negative sample to insert multiple flaws.

The hypothesis behind the current approach is that if the meta-metric learning model is capable of efficiently comparing a pair of images and extracting a reliable similarity score, it is expected a more substantial similarity between actual anomalous samples and synthetic ones than a non-anomalous sample, so the model can be trained with synthesized samples and deploy it to detect natural anomalies.

One must train it under a systematically split dataset to reliably evaluate this model. A dataset composed of smartphones A, B, C, D, and E must be split not just concerning the anomalous status but also per smartphone type, and finally, using the K-iteration validation strategy. For example, the dataset must be divided, and the model trained multiple times but using a different subset each time. Furthermore, each split must not contain all 5 smartphone types, so the model is tested under the not trained ones, e.g., train at smartphones A, B, and C, then evaluate at D, and E. Again, do another split and retrain from the start, as B, D, and E for training and A, and C for evaluating. After multiple random K iterations of train-evaluate splits, the average score is the most representative. If the model can still flag anomalies in that scenario with satisfactory scores, then the training yielded a concept drift robust anomaly detector model, which can adapt its inferences between multiple device types.

In summary, the present invention begins with a client that is looking for an anomaly detection system for smartphone brackets in his production line, where their product models are periodically updated and have less than a couple of defective units, or even none of them, to serve as sample data to train a deep learning model at the beginning of the production. The invention applies the solutions proposed, in order to provide an innovative anomaly detection system able to be trained under the lack of natural anomalous data, using synthetic data instead, along with an automatic patch detection layer, and finally becoming a concept drift robust DAD system, also known as an “open-dataset” system.

The following steps summarize what is necessary to put this invention into its best operable state.

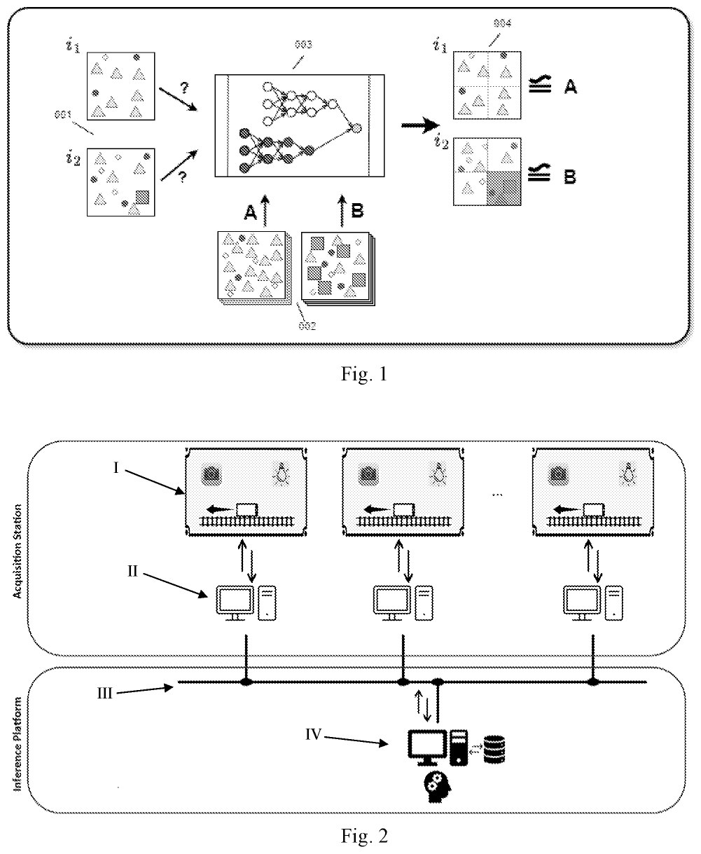

FIG. 1 represents the main working concept of the present invention. The Deep Anomaly Detector system's input 001 is compatible with batch configuration setup, i.e., it can receive multiple images to be simultaneously classified. For example, if the targeted smartphone was divided into two regions of interest, ROIs, the model can receive both in a single batch but still classifies them independently, as per any usual DL model. In the example above, the input 001 constitutes two possible ROIs i1 and i2 as query images to be classified as anomalous or not anomalous. Regarding Eq. (4), the inputs Xi are equivalent to a batch composed of i1 and i2. As a numerical representation, if a ROI has a shape equal to 512×512×3, as image height, width, and the number of channels, respectively, an input batch of two ROIs has a shape equal to 2×512×512×3.

The reference images 002 represents two groups of reference images, that is, the support set. Each group comprises of multiple images from the same class. In this example, group “A” represents non-anomalous against anomalous samples in group “B.” The triangles and the smaller shapes represent non-anomalous features of both images, with different frequencies depending on the samples. In contrast, the big squares represent anomalous features, only present in the B group. The number of images in the support set represents the K value of the few-shot method. Following the batch configuration, the support set input tensor has a shape format of N×C×K×512×512×3. The last 3 axes have the same shape of the query images in the input 001. The first axis, N, represents the batch size, or number of expected query images, being 2 in the example of FIG. 1. C is the number of possible classes available in the system, being 2 for anomaly detection ones (positive or negative), K is the K-shot value related to the few-shot technique in Eq. (4). Finally, for the example of FIG. 1, using K equals 5, the support set tensor shape is 2×2×5×512×512×3.

The inspection system comprises a main inference DL model 003. The DAD comprises a feature extractor module (FEM) and a similarity module (SM), as functions g and f in Eq. (4), respectively. The designer must define both artificial neural network architectures. Usually, convolutional neural network suits better at image processing tasks. The training operation is built around an iterative backpropagation algorithm, as per most supervised learning routines. The designer must define the input image resolution by the problem at hand, then the batch size, preferably between 16 and 64, then the K-shot value, and finally, the training hyperparameters as an optimizer, loss function, metrics, and callbacks.

After training, the model is recorded along with the support set images 002, creating a constant input tensor, which will not need to be processed by the artificial neural network at every inference operation. This way, the model only needs a query image to calculate its output. Following Eq. (4), Xⱼ and Xₘ correspond to the constant tensors of the support set, as the groups A and B in the support set of images 002. For each input query image, the model must return an output tensor 004. Such tensor contains the classification inference result for each region of interest (ROI). The classification inference is based on the similarity score between one query image and one reference group. Following the example in FIG. 1, it is expected that query image i₂ yields a higher similarity score when compared to group B of the support set 002, which shares anomalous features with i₂, than group A of the support set 002, which comprises only anomaly-free samples. Therefore, the output inference for image i₂ must belong to the same class of the group B, an anomalous image. In summary, the model does not infer the query class directly but, instead, says which image on the support set 002 it is most similar to.

FIG. 2 illustrates the present invention's general hardware structure and information flow. This architecture was explicitly developed to operate at the present invention's manufacturing deployment unit. When aiming to apply an industrial-compatible DAD system, it requires a robust infrastructure. However, the present invention's proposed core is not strictly restricted to the above-introduced architecture. The developed DAD system is compatible with an extensive range of image processing units, and its essential function is not directly bound to the overall system architecture.

The system is comprised of an acquisition station comprising an acquisition booth I, which is the image acquisition station used to automate the inspection process, comprising a photographic camera, an illumination system, sensors, communication cables, and supports mounted over the conveyor belt of the production line.

In addition, the system comprises an Automation Server II. Each cabin will have an automation server running software responsible for controlling the equipment, such as the booth, and acquiring images from the items passing through the conveyor belt. It will send the gathered images to the inference system and then will show any received response to the line inspector.

Furthermore, the system comprises a Network Infrastructure III, which is a private network used to connect the Automation Servers II (from each booth) to an Inference System IV. The network infrastructure III serves to transfer images acquired at the acquisition booth I to be inspected as the Inference System IV, and for transferring the results back to the respective automation server.

The Inference System IV is a software comprising a web application, responsible for receiving requests from the automation system, and a complex module that implements the configurable inference pipeline that, among other image processing operations, operates the Inference Model (DAD) to inspect the provided image for anomalies.

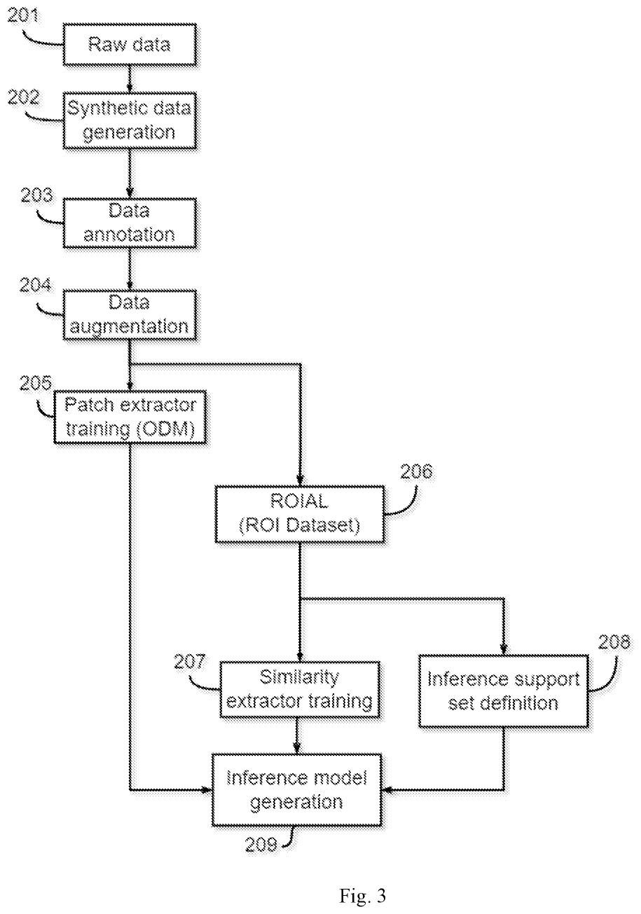

FIG. 3 illustrates the information flow of the present invention summarized in nine operations. It starts at operation 201, where all training data must be collected. This item represents the unprocessed image dataset that shall be cleaned and annotated to serve as training data for the models.

At operation 202, the user may take the actual image samples and artificially modify them with digital image processing techniques to create symbolic anomalies over images without defects. This operation must be scrutinized under the DAD designer criteria explained above, where a team of professionals works together to provide a reliable likelihood to the synthetic data.

In operation 203, data annotation, the designer must generate annotation files, specifying the coordinates of each patch of interest and anomalous regions in each image sample. For example, if the product in analysis can be divided into four ROIs, with different components to be inspected, the user must specify where each region is located. As an annotation example, a region can be tracked by the code “123 456 789 123 1” following a notation format of “initial x, initial y, final x, final y, id”, where x and y are the pixel coordinates of axis X and Y, respectively, and id is the patch identification number. This annotation represents a bounding box (BBox) with an id. For the current DAD proposal, each ROI and anomaly must be included in the annotations in every image. These BBoxes will serve as the supervised labels for both models' trainings (operations 205 and 207).

Operation 204 represents the image augmentation. The designer must provide an automatic augmentation pipeline that randomly applies multiple transformations over the dataset images and compose a more representative dataset. Which transformations should be used depends on the data context domain, which is the designer's data engineering responsibility.

In operation 205, the patch extractor, as an Object Detector Module (ODM), must be trained with the composed dataset after operation 204. Its architecture is programmed to receive an image and further process it; The ODM output is a numeric tensor object that contains the coordinates of all detected objects and their respective class identification, representing the detected patch region. For example, if the designer has defined 4 ROIs per image, the ODM output is a tensor with 4 bounding box coordinates and their respective ROI id. As described before, the present invention redirects the use of SOTA ODMs to detect image patches instead of directly looking for anomalies, which is the task applied in the next operation with the similarity module (SM). After the ODM is trained, it must be kept aside while the following operations are done. It will be reintegrated in the final operation 209.

Operation 206 is a data processing operation applied with a tool proposed by the present invention, ROIAL (ROI auto patching). To turn the SM training with ROIs possible, the ROI data must be generated from the whole images and the dataset must be structured in superclass plus subclass folders. Each ROI id represents a superclass folder. Further, the ROIs from the same superclass must be separated into two inner folders, one for anomalous and other for non-anomalous ROIs. The ROIAL tool is a computer program made to apply an automatic “filter and crop” operation. This program must read the annotation files generated in operation 203 along with all the original dataset images. In summary, the ROIAL will read one image, take its annotations, filter the ROIs by the presence of some anomaly BBox intersecting their area, crop the image by each ROI BBox, and finally, save each crop in accordance with its respective subclass.

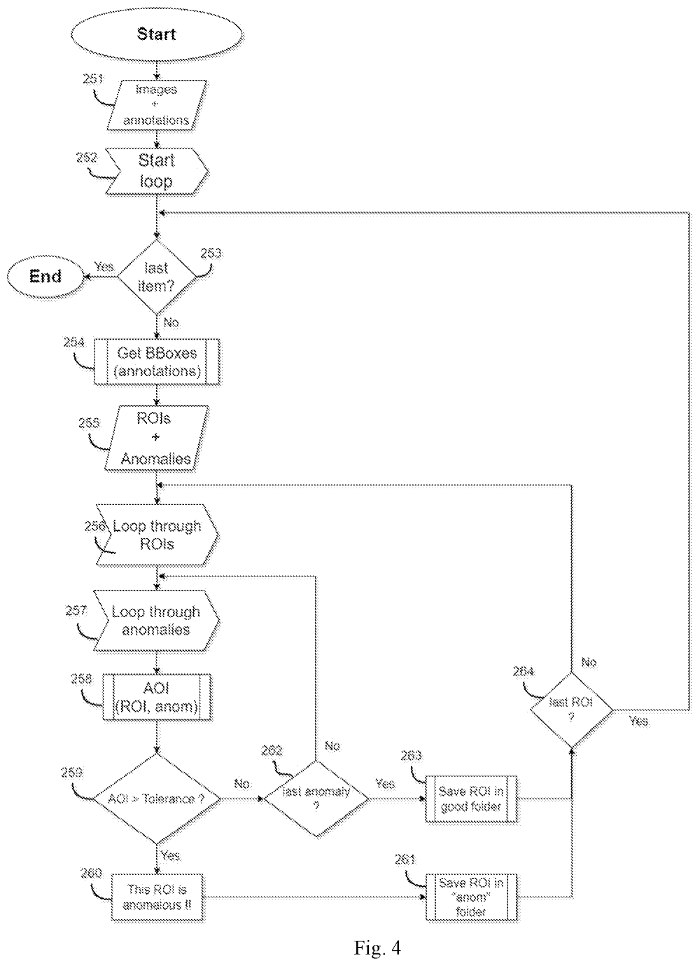

FIG. 4 illustrates the ROIAL logical flow chart. Once started, the first operation 251, represents the process of importing the original images from the training dataset, added with the respective annotations for each image. The annotations must be done during operation 203, comprising ROIs and anomalies. The imported data must then be recorded in the program's working memory.

Operation 252 starts the iteration loop for filtering the images regarding their patches and anomalies. Operation 253 refers to the loop's breaking condition. For each iteration, one image of the dataset must be imported. If there are no more images to walk through, the program ends.

The first operation inside the loop is get annotations 254, runs a processing function to get the bounding box (BBox) annotations of the respective iterated image and stores its data in the program's working memory. The annotation comprises one “.txt” file for each image in the dataset. One file contains the respective annotations for that image, that is, every ROI and anomaly BBoxes inside that image.

One image may have multiple ROIs and anomalies stored as an iterable object at operation 255. For each ROI in the present image, an inner loop must be run to walk through all the anomalies present in the iterated image. Operation 256 is responsible to log each ROI iteration inside the iterated image.

There is another deeper loop for each anomaly in the iterated image, operation 257. For every anomaly in the iterated ROI loop, a function must be run at operation 258 to calculate the geometric intersection area between the iterated ROI and iterated anomaly, the “area of intersection” (AOI). If the AOI is greater than zero, it means that the anomaly is inside the region of that ROI. Hence, it becomes recognized as an “anomalous ROI” in 260 and shall be stored in a subclass folder (operation 261) inside the respective superclass folder, depending on the ROI ID. If the AOI is less than or equal to zero, the iterated anomaly is outside that ROI. Thus, operation 257 iterates over the next anomaly in the image and repeats operation 258. But, if there are no more anomalies in this image, 262, the anomaly loop ends. If none of the tested anomalies had an AOI greater than zero, the analyzed ROI has no anomalies inside its region, so it is cropped and saved in its respective super and subclass folder in item 263. Next, the program goes further to the subsequent ROI in loop 256 and repeats all the past operations.

After finishing all the loops, the program should have analyzed all the images, ROIs, and anomalies, extracting the intersection relation between them to save the ROIs in addressed folders. Each ROI region has a top-level folder (superclass) containing two inner folders (subclasses), one to store the non-anomalous ROIs and the other for the anomalous ones.

The ROIAL program's result is a new dataset composed of ROI crops derived from the original images in the first dataset. All cropped ROIs are saved in their respective ID folder (superclass) along with their classification state under two inner folders (subclasses), anomalous or non-anomalous. This dataset must be used to train the SM deep learning model.

Operation 207 in FIG. 3 shows the SM training operation. Since it is a meta-metric learning-based model, its training operation is more complex than the ODM. For each training epoch, a data generator program must randomly choose a pack of images with no anomalies and another pack with multiple anomalies to serve as groups A and B of the support set 002 in FIG. 1. Further, the same function must randomize another pack of images to be the query set. These images have random classes (anomalous or non-anomalous), and they must be classified by the model iteratively through the training epochs, so the model can learn how to compare the query with each reference group in the support set, according to Eq. (4).

After the SM is trained, it is not ready to make inferences. First, a fixed support set must be defined in 208, where the user chooses which images from the dataset will serve as positive and negative references to the model. For instance, if the next device to be manufactured is of type A, the designer must compose a fixed support set of A images. Then, the first artificial neural network in the pipeline, the ODM, must be taken and prepared to receive the input inference batch in input 001 in FIG. 1. The output of the ODM must be programmed to become the input of the SM model. This customization between the two separated models composes the inference model, operation 209, that represents the final art of the present invention.

The function generated at operation 209 depicts the process of generating a trained model, ready to make inferences over a predetermined device version. After this point, the designer may change the object in the analysis by choosing the new support set following the application process and running the inference model generator function to adapt it to the new manufacturing object. This concludes the method to generate the DAD system that is easily adjusted to new device types without the expensive costs of collecting more data and retraining the model every time a new device comes.

Finally, another substantial advantage of this method is that new data can be collected and pilled over the previous datasets for each new device in the manufacturing line. Consequently, the model can be periodically retrained under an offline setup, making it more robust over time.

### Alternative Embodiments

The first embodiment of the present invention is designed to work with substantially restricted systems in terms of dataset size. The patch extraction operation is planned to further improve the model's generalization capacity. However, this is a preferential feature. If the desired application comes with a more representative dataset, or if the designer wishes to turn the system more straightforwardly, it is possible to ignore the patch extraction feature. It is essential to account for the patch extraction's impact on the model's final effectivity on concept drift robustness. Still, it also comes with a higher implementation complexity that may overestimate the complexity of the problem. For example, a DAD system should detect anomalies in QR code tags in some product manufacturing line. In that case, the present method should be enough to deal with this problem without the patch extraction operation, saving up implementation time and setup complexity. The 2nd embodiment explains how to develop the same system suppressing the patch extraction operation but keeping the meta-metric-learning emphasis on maintaining the concept drift robustness.

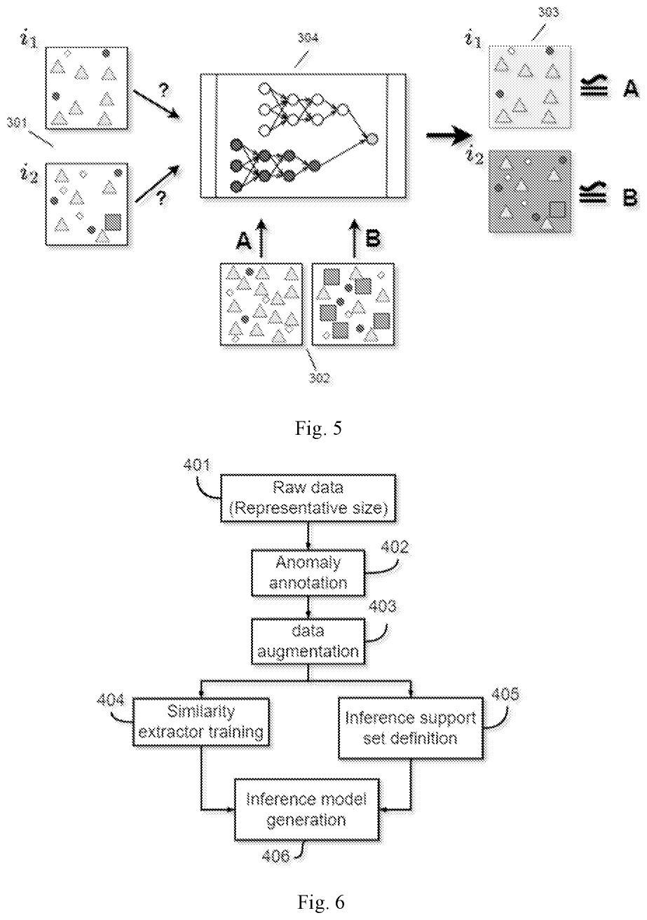

FIG. 5 illustrates how this would change the output of model 304 when compared with the first embodiment. In item 303, the output comes without the patch classification feature, where the whole image is classified as anomalous or not anomalous.

The second embodiment's structure is nearly the same as the first embodiment. To change how the system works, FIG. 6 illustrates the new information flow. Since this kind of operation counts with a better-represented dataset, it may also ignore the synthetic data generation operation (optional, depending on the designer's evaluation of the new problem and available data), going direct to the automatic data augmentation operation in 403, which turns the whole implementation simpler under the cost of effectivity loss, which may not be a concern if the problem at hand be significantly more manageable and have better data supply.

The method of FIG. 6 represents a method comprising the operations of obtaining 401 the raw dataset with a representative size and including multiple manufacturing product images and annotation files with coordinates of predetermined anomalous regions on each manufacturing product image. The annotation files may result from the anomaly annotation operation 402. In addition, the method comprises training 404 a similarity extractor module by selecting a test query set and a support set of images from the dataset multiple. The support set of images comprising pairs of reference images and each pair comprises one anomalous and one non-anomalous manufacturing product images. To conclude the training, the parameters characterizing the model are adjusted with basis on a model based on the similarity score.

However, even if the new problem still suffers from concept drift scenarios, e.g., inspecting only QR codes in periodically updated product lines, the second embodiment remains robust to it.

This operation mode does not require the ROJAL operation in item 209, simplifying the system. After the data augmentation operation, the SM can be directly trained with the full-sized images, following the same training strategy of the first embodiment but now classifying the image as a single patch.

To generate the final inference model, 406, the ODM is unnecessary. For the present implementation, the SM must be directly reintegrated with constant support set inputs to operate with the input query images, as in the first embodiment.

### Effect

In the current invention's experiments, a dataset was composed of three smartphone types summing 790 images, where 514 are non-defective (negative) and 276 synthesized anomalous (positive) samples, following the synthesis criteria previously cited. The DAD model was trained under 5-folder split iterations, and the scores were averaged. Each iteration splits the training data into two subsets, 80% for training and 20% for validating. The validation set guarantees that the model has not been overfitted. Moreover, the experiments carry another layer of data splitting. Since there are three smartphone versions and the core problem related to this invention is the concept drift robustness, splitting the dataset into two parts is not precisely reliable to evaluate the model's capacity to self-adapt to smartphones outside the whole dataset. Hence, three experiments were run separately, each with one smartphone type removed from the dataset. This device was used as the final test data. Finally, the results were compared for each model to see if they could generalize their inferences on the three smartphones that have not made part of training operation.

Another key tested parameter was the few-shot K-value configuration (the number of images per support set). It was trained with K equal to 1, 5, and 10, respectively. The 10-shot configuration was the experimental system's VRAM limit capacity, 24 GB of an RTX 3090 Ti GPU.

The evaluation procedure of anomaly detection systems is not just based on the model's accuracy. The raw accuracy is unreliable for evaluating models trained at imbalanced datasets and anomaly detector systems. In some cases, a dataset comprises 99% negative (non-defective) samples, and the model performs with 99% accuracy. It virtually means it has just learned to infer all instances as negative, becoming a useless model.

Imbalanced dataset systems are evaluated under their precision and recall performances to provide a more reliable metric. The former indicates the relative proportion of negative samples that were correctly predicted, and the latter as the opposite, showing the relative proportion of positive samples predicted as negative, also called a False Negative rating, or missed anomalies rating.

Usually, the most valuable metric under anomaly detection scenarios is the recall because it indicates the probability of the model inferring a defective sample as a non-defective one. When it happens, that device may be sold in the market when it should be filtered during its manufacturing.

When dealing with the balance between precision and recall, a usual analysis approach is called confusion matrix threshold adjustment. For a binary classification system (anomaly or regular), the model's inference is based on the numeric approximation in the floating-point interval between 0 and 1. By default, if the model's output is less than or equal to 0.5, it is treated as a negative inference. If it is greater than 0.5, it is a positive inference. However, no rule restricts this inference threshold. The designer is free to modulate this interval following his critical discernment.

Picking a higher threshold point may increase the precision score while decreasing it can improve the recall. Besides the designer's choice of threshold point, there is also a metric called the F1 score. This metric essentially evaluates the harmonic mean between precision and recall, measuring their balance, and it can help the designer decide which threshold best suits the system.

In the present invention's experiments, only two device types were used during training to evaluate the proposed DAD robustness to concept drift scenarios. The left one was kept aside to serve as test data. This splitting approach leads to approximately 580 training images. Three training rounds were performed, one for each device kept aside. For example, train the DAD with smartphones A and B in the first iteration, then evaluate in C. Next, reset the model and train it with devices A and C, evaluate at B, and so on. For every training iteration, the model has shown a substantial evaluating performance on the device, which was not present in the train dataset split, as shown in Table 1.

TABLE 1
Results of experiments according to the present invention

| | | Mean | Mean | Mean |
|---|---|---|---|---|
| | | Accuracy | Precision | Recall |
| Smartphone | K-shots | (%) | (%) | (%) |
| A | 1 | 96.88 | 95.37 | 98.75 |
| | 5 | 98.74 | 97.04 | 99.23 |
| | 10 | 98.92 | 97.84 | 99.29 |
| B | 1 | 90.86 | 82.00 | 96.50 |
| | 5 | 99.74 | 98.48 | 99.90 |
| | 10 | 99.76 | 98.67 | 99.90 |
| C | 1 | 67.21 | 64.40 | 84.53 |
| | 5 | 94.52 | 92.63 | 97.78 |
| | 10 | 94.89 | 93.12 | 98.21 |

The experiment results summarize the K-values tested, measuring accuracy, precision, and recall. The threshold point decided by the development team was adjusted by each smartphone version, aiming to return a higher recall rate without substantially penalizing the F1 score, meaning fewer flawed samples are missed. Once positive inferences are filtered in the manufacturing line, the human manufacturing inspector may focus on these samples and increase his effectiveness instead of randomly picking a sample to inspect. When a False Positive sample gets separated from the manufacturing line, the inspector shall analyze if this is a False Positive sample. If it is the case, the product may return to the line instead of being discarded.

Taking the K-value into consideration in the training setup, it was possible to notice a substantial efficacy improvement above 1-shot values, but the difference between 5-shots and 10-shots is less significant. Furthermore, even under repetitive training iterations for the 1-shot setup, device C suffered an abnormal loss of effectiveness. This evidence contemplates how the few-shot technique can significantly improve the model's stability under concept drift scenarios.

When comparing the inference time for multiple-shot setups, the model operates at approximately 45 ms per inference in 5-shot and 80 ms in 10-shot. Considering one image subdivided into 5 ROI patches, the 5-shot setup takes about 220 ms and the 10-shot, about 400 ms. Although a single inference may take relatively low processing time, if the system be configured with too many shots and ROIs, the inference time can quickly extrapolate. The 5-shot scenario combined with 5 ROI patches in the current experiments seems to return the most satisfactory balance between effectivity and inference time.

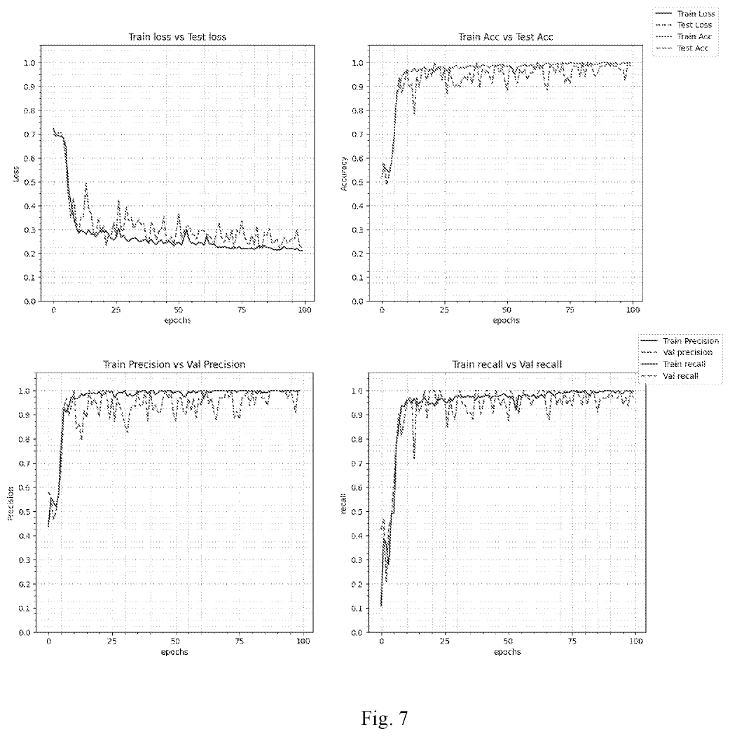

FIG. 7 illustrates the model's training history average between the multiple experiments. Both training and validation curves are bound to the data where the device types are present in the training sets. All trained models perform above 99% scores (accuracy, precision, and recall). However, once the training operation is validated under the same device types, that score is not reliable under concept drift scenarios. Notwithstanding, it serves to evaluate the model's overfitting rate. Table 1 shows how these scores decrease when the model is evaluated on a device absent from training data. This evaluation demonstrates how critical the impact is when applying the model outside its training data domain. Still, the current invention model achieved satisfactory results under those circumstances, proving its open-dataset applicability.

The exemplificative embodiments described herein may be implemented using hardware, software, or any combination thereof and may be implemented in one or more computer systems or other processing systems. Additionally, one or more of the operations described in the example embodiments herein may be implemented, at least in part, by machines.

For instance, one illustrative example system for performing the operations of the embodiments herein may include one or more components, such as one or more microprocessors, for performing the arithmetic and/or logical operations required for program execution, and storage media, such as one or more disk drives or memory cards (e.g., flash memory) for program and data storage, and random-access memory, for temporary data and program instruction storage.

Therefore, the present invention is also related to a system for detecting food intake comprising a processor and a memory comprising the computer-readable instructions that, when performed by the processor, cause the processor to perform the method operations previously described in this disclosure.

The system may also include software resident on a storage media (e.g., a disk drive or memory card), which, when executed, directs the microprocessor(s) in performing transmission and reception functions. The software may run on an operating system stored on the storage media, such as, for example, UNIX or Windows, Linux, Android, and the like, and can adhere to various protocols such as the Ethernet, ATM, TCP/IP protocols and/or other connection or connectionless protocols.

As well known in the art, microprocessors can run different operating systems and contain different software types, each type being devoted to a different function, such as handling and managing data/information from a particular source or transforming data/information from one format into another format. The embodiments described herein are not to be construed as being limited for use with any particular type of server computer, and any other suitable device for facilitating the exchange and storage of information may be employed instead.

Software embodiments of the illustrative example embodiments presented herein may be provided as a computer program product or software that may include an article of manufacture on a machine-accessible or non-transitory computer-readable medium (also referred to as “machine-readable medium”) having instructions. The instructions on the machine-accessible or machine-readable medium may be used to program a computer system or other electronic device. The machine-readable medium may include, but is not limited to, floppy diskettes, optical disks, CD-ROMs, magneto-optical disks, or another type of media/machine-readable medium suitable for storing or transmitting electronic instructions.

Therefore, the present invention also relates to a non-transitory computer-readable storage medium for detecting anomalies in a manufacturing product, comprising computer-readable instructions that, when performed by the processor, cause the processor to perform the method operations previously described in this disclosure.

The techniques described herein are not limited to any particular software configuration. They may be applicable in any computing or processing environment. The terms “machine-accessible medium,” “machine-readable medium” and “computer-readable medium” used herein shall include any non-transitory medium that can store, encoding, or transmitting a sequence of instructions for execution by the machine (e.g., a CPU or other type of processing device) and that cause the machine to perform any one of the methods described herein. Furthermore, it is common in the art to speak of software in one form or another (e.g., program, procedure, process, application, module, unit, logic, and so on) as acting or causing a result. Such expressions are merely a shorthand way of stating that the execution of the software by a processing system causes the processor to act to produce a result.

While various exemplary embodiments have been described above, it should be understood that they have been presented by example, not limitation. It is apparent to persons skilled in the relevant art(s) that various changes in form and detail can be made therein.

What is claimed is:

1. A method of training a neural network to detect anomalies in a manufacturing product, comprising:
obtaining a dataset including multiple manufacturing product images and annotation files with coordinates of predetermined anomalous regions corresponding to the multiple manufacturing product images, respectively;
selecting a test query set of images and a support set of images from the dataset multiple times to train a deep learning model, the support set of images including pairs of reference images and each pair including at least one anomalous manufacturing product image and at least one non-anomalous manufacturing product image;
inputting the test query set into a deep learning model to rate a similarity score based on a similarity distance between the pairs of reference images of the support set of images based on the annotation files; and
adjusting parameters characterizing the deep learning model through a model based on the similarity score.

2. The method according to claim 1, further comprising:
generating synthetic data by processing a raw dataset to apply symbolic anomalies on the multiple manufacturing product images; and
applying the synthetic data into the deep learning model to identify relevant regions of interest (ROIs), of each one of the multiple manufacturing product images with symbolic anomalies.

3. The method according to claim 2, further comprising:
generating annotation files including coordinates of relevant ROIs and anomalous regions of the synthetic data; and
generating a composed dataset by applying data augmentation over the synthetic data.

4. The method according to claim 3, further comprising:
training an object detector module with the composed dataset to output a tensor object containing coordinates of each detected object and a respective class identification; and
setting the output of the object detector module as an input of the deep learning model.

5. The method according to claim 2, further comprising:
processing the synthetic data to generate a ROI dataset based on the annotation files and the raw dataset, wherein the ROI data includes two sets of ROIs with anomalous and non-anomalous ROIs, respectively.

6. The method according to claim 5, further comprising:
selecting two random sets of ROI images from the ROI dataset, a first set including images with no anomalies and a second set including images with multiple anomalies.

7. The method according to claim 6, wherein the test query set of images is compared with the two random sets of ROI images to train a similarity model, and the test query set of images and a fixed support set of images are selected from the ROI dataset.

8. The method according to claim 5, wherein that processing the synthetic data to generate ROI data further comprises:
importing original images from the training dataset with a respective annotation for each image; and
executing an iteration loop to filter the images with respect to patches and anomalies, wherein one image of the dataset is imported for each iteration.

9. The method according to claim 8, wherein the processing the synthetic data to generate ROI data further comprises:
getting bounding box (BBox) annotations of a respective iterated image and storing data of the BBox annotations.

10. The method according to claim 9, further comprising:
based on an image including multiple ROIs and anomalies, storing the image as an iterable object and executing a loop though all ROIs and anomalies;
logging each ROI iteration inside an iterated image;
running a loop for each anomaly in the iterated image;
calculating an area of intersection between the iterated ROI and the iterated anomaly, and
based on the area of intersection being greater than zero and surpass a limit threshold, determining the iterated ROI as an anomalous ROI and saving the ROI in an anomalous ROI folder.

11. A method of detecting anomalies in a manufacturing product, comprising:
obtaining at least one image of a manufacturing product to be inspected;
inputting the at least one image obtained in a neural network trained to compare a manufacturing product image with pairs of reference images including at least one anomalous manufacturing product image and at least one non-anomalous manufacturing product image, the pairs of reference images being stored as a support set of images;
rating a similarity distance score between the at least one image obtained and the pairs of reference images; and
determining whether the manufacturing product is anomalous based on the similarity distance score.

12. The method according to claim 11, further comprising:
setting another support set comprising images of a different version of the manufacturing product.

13. An inspection system to detect anomalies in a manufacturing product comprising:
an imaging system configured to obtain an image of a manufacturing product; and
a computer system including a memory device and a processor, the computer system being connected to the imaging system;
the processor is configured to:
obtain at least one image of a manufacturing product to be inspected;
input the at least one image obtained in a neural network trained to compare a manufacturing product image with pairs of reference images including at least one anomalous manufacturing product image and at least one non-anomalous manufacturing product image, the pairs of reference images being stored as a support set of images;
rate a similarity distance score between the at least one image obtained and the pairs of reference images; and
determine whether the manufacturing product is anomalous based on the similarity distance score.

14. The inspection system according to claim 13, wherein the processor is further configured to:
set another support set comprising images of a different version of the manufacturing product used to train a model.

15. The inspection system according to claim 14, further comprising an additional deep learning model configured as an object detector module (ODM) to identify relevant regions of interest (ROIs) in multiple manufacturing product images.

16. The inspection system according to claim 13, wherein the memory device stores a deep learning model and the support set of images.

17. The inspection system according to claim 16, wherein the deep learning model returns an output tensor for each query image, and the output tensor comprises coordinates of all detected objects and a classification inference result based on the similarity score between each query image and the support set of images.

18. The inspection system according to claim 13, comprising an acquisition booth (I) to automate the inspection and including an imaging system, wherein the imaging system includes a photographic camera, an illumination system and sensors.

19. A non-transitory computer readable medium having computer readable instructions stored thereon which, when executed on a processor, cause a computer to perform a method as defined in claim 1.
